(19) United States
(12) Patent Application Publication
(10) Pub. No.: US 2026/0080060 A1
(43) Pub. Date: Mar. 19, 2026

(54) PROTECTION CONTROLLER AND METHOD TO OPERATE IN COMPUTER SYSTEM

(71) Applicant: Huawei Cloud Computing Technologies Co., Ltd., Gui'an New District (CN)

(72) Inventors: Omer Anson, Hod Hasharon (IL); Yoni Birman, Munich (DE); Avi Chalbani, Hod Hasharon (IL)

(73) Assignee: Huawei Cloud Computing Technologies Co., Ltd., Gui'an New District (CN)

(21) Appl. No.: 19/333,638

(22) Filed: Sep. 19, 2025

Related U.S. Application Data
(63) Continuation of application No. PCT/EP2023/057047, filed on Mar. 20, 2023.

(51) Int. Cl. G06F 21/56; G06F 11/14; G06F 21/55

(52) U.S. Cl. CPC G06F 21/568; G06F 11/1451; G06F 21/552

(57) ABSTRACT

A protection controller configured to operate in a computer system, including a process, an operating system and at least one memory disk. The protection controller is further configured to receive a memory disk request for a file, determine that the memory disk request is a WRITE request indicating a modification to the file, and, in response thereto, generate a backup copy of the file prior to the modification. Furthermore, the protection controller is configured to determine that the process includes ransomware and, in response thereto, recover the file based on the backup copy to provide zero-loss ransomware protection to the computer system with an improved overall data security.

### CROSS-REFERENCE TO RELATED APPLICATIONS

This application is continuation of International Application No. PCT/EP2023/057047, filed on Mar. 20, 2023, the disclosure of which is hereby incorporated by reference in its entirety.

### FIELD

The present disclosure relates generally to the field of data security and to a protection controller and a method to operate in a computer system comprising a process, an operating system, and at least one memory disk.

### BACKGROUND

Malware, such as ransomware, crypto-miners, spyware, bots, trojans, worms and the like, are the most prominent cyber threats to an individual as well as to an organization when it comes to a data security. In general, the malware refers to a software that is designed for compromising a computer system, such as by destroying the data stored in the computer system or restricting a user from accessing the data stored in the computer system. Therefore, such a malware attack results in significant pecuniary loss, data loss, or a system failure.

Conventionally, certain attempts have been made to mitigate the risk of the malware attack, such as by using periodic backups, antivirus software, and the like. However, such attempts fail due to many reasons, such as due to accumulation of data and data loss between a certain interval of time during a periodic backing up of the data or non-instantaneous malware detection. Due to these reasons, conventional malware detection techniques are ineffective to mitigate the risk of the malware attack that causes huge pecuniary loss and data loss. As a result, there exists a technical problem of how to eliminate the adverse effect of the malware efficiently and accurately to improve the overall data security of the computer systems in order to protect the computer system from the malware attack.

Therefore, in light of the foregoing discussion, there exists a need to overcome the aforementioned drawbacks associated with the conventional methods to protect computer systems from the malware attacks.

### SUMMARY

The present disclosure provides a protection controller and a method to operate in a computer system that includes a process, an operating system, and at least one memory disk. The present disclosure provides a solution to the existing problem of how to eliminate the adverse effect of the malware efficiently and accurately to improve the overall data security of the computer systems in order to protect the computer system from the malware attack. An embodiment of the present disclosure provides a solution that overcomes at least partially the problems encountered in the prior art and provides an improved protection controller and an improved method to operate in a computer system comprising the process, the operating system, and at least one memory disk, such as by providing a zero-loss resource optimised ransomware protection.

In one aspect, the present disclosure provides a protection controller configured to operate in a computer system comprising a process, an operating system, and at least one memory disk. The protection controller is configured to receive a memory disk request for a file, determine that the memory disk request is a WRITE request indicating a modification to the file, and, in response thereto, generate a backup copy of the file prior to the modification, determine that the process includes ransomware and in response thereto recover the file based on the backup copy.

The protection controller of the computer system is configured to generate the backup copy of the file prior to any modification whenever a memory disk request that indicates a WRITE request is received by the protection controller. The backup copy of the file is further used to recover an original copy of the file whenever the ransomware is detected during the execution of the process to eliminate the adverse effect of the ransomware. Furthermore, the protection controller is configured to monitor the behavior of the processes, the operating system, and the memory disk request to provide overall data protection. In addition, the protection controller is configured to detect the ransomware in the process, such as through a ransomware detection solution. For example, if a malware is detected after ten (10) writes that represent 2% of the disk, then, in that case, the protection controller is configured to recover the file that is adversely affected by the malware. Furthermore, the protection controller is configured to terminate the process, such as when the malware is detected, when the process is timed out, or when the process is deemed benign. Thereafter, the protection controller is configured to delete the backup copy of the file after the termination of the process to provide an improved and reduced resource utilization, such as by reducing the utilization of the storage (i.e., through minimum written files and written bytes). In addition, the protection controller is configured to provide both file-level and block-level protection, such as by backing up the entire file or by backing up the modified blocks of the memory disk to provide a backup-on-write and ransomware detection mechanism. Therefore, the protection controller is configured to provide zero-loss ransomware protection to the computer system with an improved overall data security.

In an implementation, the protection controller is further configured to monitor the process of receiving the memory disk request.

The monitoring of the process is used to determine the nature of the process, such as a malicious process or a non-malicious process.

In a further implementation, the protection controller is further configured to recover the file by replacing modified blocks in the modified file with corresponding blocks in the backup copy.

In such an implementation, the recovery of the file by replacing modified blocks in the modified file with the corresponding blocks in the backup copy eliminates the adverse effect of the ransomware attack.

In a further implementation, the protection controller is further configured to generate the backup copy consisting of the modified blocks.

Advantageously, the generation of the backup copy of the file can be used to recover the file, such as by replacing the modified file with the backup copy to eliminate the effect of the ransomware.

In a further implementation form, the protection controller is further configured to determine that the process does not comprise ransomware and, in response, thereto delete the backup copy.

The deletion of the backup copy of the file reduces the utilization of resources (e.g., the resources that are used for storing the backup copy) with an improved overall data security.

In another aspect, the present disclosure provides a method for a protection controller configured to operate in a computer system comprising a process, an operating system, and at least one memory disk. The method includes receiving a memory disk request for a file, determining that the memory disk request is a WRITE request indicating a modification to the file, and, in response thereto, generating a backup copy of the file prior to the modification, determining that the process includes ransomware and, in response thereto recovering the file based on the backup copy.

The method achieves all the advantages and technical effects of the protection controller of the present disclosure.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of a protection controller configured to operate in a computer system, in accordance with an embodiment of the present disclosure;

FIG. 2 depicts a flowchart of a method for a protection controller, in accordance with an embodiment of the present disclosure;

FIG. 3 depicts an exemplary diagram that depicts an architecture of a computer system, in accordance with an embodiment of the present disclosure;

FIG. 4 depicts an exemplary diagram that depicts monitoring by a virtual machine monitor, in accordance with an embodiment of the present disclosure;

FIG. 5 depicts an exemplary diagram that depicts an execution of the memory disk request for a file, in accordance with an embodiment of the present disclosure; and

FIG. 6 depicts an exemplary diagram that depicts a sequence of execution of a process, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates example embodiments of the present disclosure and ways in which they can be implemented. Although some modes of carrying out the present disclosure have been disclosed, those skilled in the art would recognize that other embodiments for carrying out or practicing the present disclosure are also possible.

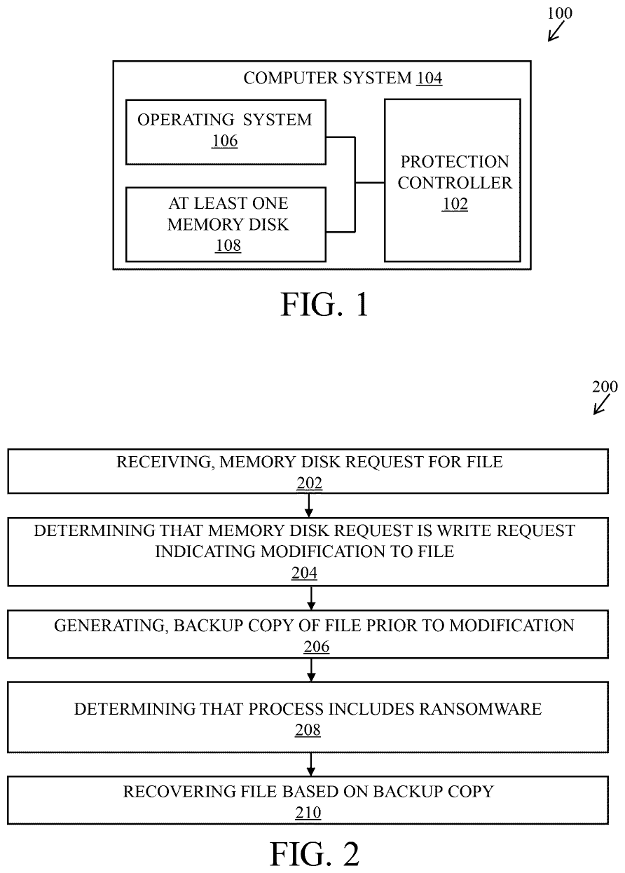

FIG. 1 depicts a block diagram of a protection controller configured to operate in a computer system, in accordance with an embodiment of the present disclosure. With reference to FIG. 1, there is shown a block diagram 100 of a protection controller 102 that is configured to operate in a computer system 104. Moreover, the computer system 104 further includes an operating system 106 and at least one memory disk 108.

The protection controller 102 is configured to operate in the computer system 104. Examples of the protection controller 102 may include, but are not limited to, a microcontroller, a microprocessor, a central processing unit (CPU), a complex instruction set computing (CISC) processor, an application-specific integrated circuit (ASIC) processor, a reduced instruction set (RISC) processor, a very long instruction word (VLIW) processor, a data processing unit, and other processors or control circuitry. Moreover, examples of the computer system 104 may include but are not limited to a user equipment, such as a computer, a personal digital assistant, a portable computing device, or an electronic device.

The at least one memory disk 108 is configured to store files. Examples of the at least one memory disk 108 may include, but are not limited to, a hard disk drive (HDD), a solid-state drive (SSD), a hybrid hard drive (HHD), a floppy disk, a USB Flash Drive, a memory stick, an SD card (secure digital card), a microSD card, a compact flash (CF) card, and the like.

In operation, the protection controller 102 is configured to operate in the computer system 104, which includes a process, the operating system 106, and the at least one memory disk 108. In an implementation, the protection controller 102 is a stand-alone entity. In another implementation, the protection controller 102 is a part of the at least one memory disk 108. In yet another implementation, the protection controller 102 is a part of a network entity for the computer system 104. In another implementation, the protection controller 102 is a part of a client controller. In an implementation, the computer system 104 is a virtual machine system. In another implementation, the computer system 104 is a physical machine system without affecting the scope of the present disclosure. In addition, the protection controller 102 of the computer system 104 allows effective resource utilization.

The protection controller 102 is configured to receive a memory disk request for a file. In other words, the protection controller 102 is configured to receive the memory disk request that includes a request to perform certain actions on the file that is stored in the at least one memory disk 108, such as a WRITE request or a READ request. In an implementation, the protection controller 102 is configured to receive the memory disk request, such as by running and receiving events related to the memory disk request on the computer system 104 for the file that is stored in the at least one memory disk 108. In accordance with an embodiment, the protection controller 102 is further configured to receive the memory disk request for the file by utilizing operating system services to perform file activity monitoring. The utilization of the operating system services to perform file activity monitoring improves the overall data security of the computer system 104. In an implementation, the protection controller 102 is further configured to monitor the process for receiving the memory disk request. In other words, the monitoring of the process for receiving the memory disk request is used to determine the type of the memory disk request, such as the WRITE request or the READ request and to determine the nature of the process, such as a malicious process or a non-malicious process. In another implementation, the protection controller 102 is further configured to monitor the operating system 106 for receiving the memory disk request. In other words, the operating system 106 that is used for receiving the memory disk request is monitored by using the operating system services to protect the computer system 104 from ransomware. In yet another implementation, the protection controller 102 is further configured to monitor the at least one memory disk 108 for receiving the memory disk request. The monitoring of the at least one memory disk 108 for receiving the memory disk request is used to ensure that the corresponding memory disk request from the at least one memory disk 108 is not attacked by the ransomware. Thus, improved the overall data security of the computer system 104 by monitoring the operating system 106 for receiving the memory disk request.

The protection controller 102 is further configured to determine that the memory disk request is the WRITE request indicating a modification to the file and, in response, thereto generate a backup copy of the file prior to the modification. In an implementation, if the memory disk request is the write request that indicates the modification of the file, then, in that case, the protection controller 102 is configured to generate the backup copy of the file prior to the modification of the file. However, if the memory disk request is not the write request that indicates the modification of the file, then, in that case, the protection controller 102 is not configured to generate the backup copy of the file. As a result, the generation of the backup copy of the file prior to the modification of the file is used to recover the file if in case the file is adversely affected by the ransomware. In accordance with an embodiment, the protection controller 102 is further configured to generate the backup copy consisting of the modified blocks. In an example, the protection controller 102 is configured to generate the backup copy by backing up the modified blocks only. As a result, the protection controller 102 is configured to support block-level protection. However, the protection controller 102 is configured to support file-level protection without affecting the scope of the present disclosure, such as by generating the backup copy of the entire file prior to the modification of the file.

Furthermore, the protection controller 102 is configured to determine that the process includes ransomware and, in response thereto, recover the file based on the backup copy. Firstly, the protection controller 102 is configured to receive the memory disk request for the file. Thereafter, the protection controller 102 is configured to determine if the memory disk request is the WRITE request indicating the modification of the file. In such a case, the protection controller 102 is configured to generate the backup copy of the file prior to the modification of the file. After that, the protection controller 102 is configured to determine that the process includes the ransomware. Moreover, if the process includes the ransomware, then, in that case, the protection controller 102 is configured to recover the file based on the backup copy. In an implementation, the protection controller 102 is further configured to recover the file by replacing the modified file with the backup copy. For example, if the backup copy of the file prior to the modification of the file is generated through file-level protection, such as by backing up the entire file, then, in that case, the protection controller 102 is configured to recover the file by replacing the modified file with the backup copy of the file. Similarly, in another implementation, the protection controller 102 is further configured to recover the file by replacing modified blocks in the modified file with corresponding blocks in the backup copy. For example, the protection controller 102 is configured to generate the backup copy of the file by backing up the modified blocks, such as by providing block-level backup protection. In such a case, the protection controller 102 is configured to replace the modified blocks in the modified file with the corresponding blocks in the backup copy. As a result, the protection controller 102 is configured to recover the file after the modification of the file to eliminate the adverse effect of the ransomware attack. Thus, the protection controller 102 provides an improved data security for the computer system 104.

In accordance with an embodiment, the protection controller 102 is further configured to determine that the process does not include the ransomware by receiving an indication to this effect. The protection controller 102 is configured to determine if the process includes the ransomware or not, such as by receiving the indication. For example, the protection controller 102 receives an indication that indicates that the process includes the ransomware. Thereafter, the file is recovered, such as by replacing the modified file with the backup copy of the file. Similarly, the protection controller 102 receives another indication that indicates that the process does not include the ransomware. Thus, the indication received by the protection controller 102 is used to determine if the process includes the ransomware or not. In accordance with an embodiment, the protection controller 102 is further configured to determine that the process does not include the ransomware and, in response thereto, delete the backup copy. In other words, if the process does not include the ransomware, then, in that case, the backup copy of the file, which is generated to recover the file is deleted. In an implementation, the protection controller 102 is configured to determine that the process does not include the ransomware through other controllers, such as by receiving a notification from the other controllers (i.e., other than the protection controller 102). Thus, the deletion of the backup copy provides an improved utilization of resources (e.g., the resources that are used for storing the backup copy) with an improved overall data security. In accordance with an embodiment, the protection controller 102 is further configured to determine that the process has been terminated and, in response, thereto delete the backup copy. The process is terminated when the memory disk request of the corresponding memory disk request is executed and does not require any further execution. For example, if the memory disk request for the file is the WRITE request, then, in that case, the protection controller 102 is configured to delete the backup copy of the file that is generated prior to the modification (i.e., before the execution of the WRITE request). In accordance with an embodiment, the protection controller 102 is further configured to determine that a timeout has occurred and, in response, thereto delete the backup copy. As a result, the space that is used to store the backup copy of the file is further utilized to store other data.

The protection controller 102 of the computer system 104 is configured to generate the backup of the file prior to any modification so that the file can be recovered in future if the corresponding file is affected by the ransomware. Furthermore, the protection controller 102 is configured to delete the backup copy of the file after the execution of the process to provide an improved and reduced resource utilization, such as by reducing the utilization of the storage for storing the backup copy. Therefore, the protection controller 102 is configured to provide zero-loss ransomware protection to the computer system 104 with improved overall data security of the computer system 104.

FIG. 2 depicts a flowchart of a method for a protection controller, in accordance with an embodiment of the present disclosure. With reference to FIG. 2, there is shown a flowchart of method 200 for use in the protection controller 102 that is configured to operate in the computer system 104 (of FIG. 1), including the process, the operating system 106 and the at least one memory disk 108. The method 200 includes steps 202 to 210.

In operation, the method 200 includes receiving a memory disk request for a file, such as at step 202. In other words, the protection controller 102 is configured to receive the memory disk request that includes a request to perform certain actions on the file that is stored in the memory disk from the at least one memory disk 108, such as a WRITE request or a READ request. Furthermore, at step 204, the method 200 includes determining that the memory disk requested is the WRITE request indicating a modification to the file. In an implementation, the protection controller 102 is configured to receive the memory disk request, such as by running and receiving events related to the memory disk request on the computer system 104 for the file that is stored in the at least one memory disk 108. Furthermore, at step 206, the method 200 includes generating the backup copy of the file prior to the modification after determining that the memory disk request is the WRITE request. In an implementation, if the memory disk request is the WRITE request that indicates the modification of the file, then, in that case, the protection controller 102 is configured to generate the backup copy of the file prior to the modification of the file. However, if the memory disk request is not the write request that indicates the modification of the file, then, in that case, the protection controller 102 is not configured to generate the backup copy of the file. As a result, the generation of the backup copy of the file prior to the modification of the file is used to recover the file if in case the file is adversely affected by the ransomware. Furthermore, at step 208, the method 200 further includes determining that the process includes the ransomware and, in response, thereto recovering the file based on the backup copy, such as at step 210. Firstly, the protection controller 102 is configured to receive the memory disk request for the file. Thereafter, the protection controller 102 is configured to determine if the memory disk request is the WRITE request indicating the modification of the file. In such a case, the protection controller 102 is configured to generate the backup copy of the file prior to the modification of the file. After that, the protection controller 102 is configured to determine that the process includes the ransomware. Moreover, if the process includes the ransomware, then, in that case, the protection controller 102 is configured to recover the file based on the backup copy. As a result, the file can be recovered even after the modification of the file to eliminate the adverse effect of the ransomware attack. Thus, provides an improved data security for the computer system 104.

The method 200 is used to generate the backup of the file prior to any modification so that the file can be recovered in future if the corresponding file is affected by the ransomware. Furthermore, the method 200 is used to delete the backup copy of the file after the execution of the process to provide an improved and reduced resource utilization, such as by reducing the utilization of the storage for storing the backup copy. Therefore, the method 200 provides zero-loss ransomware protection to the computer system 104 with an improved overall data security of the computer system 104.

The steps 202 to 210 are only illustrative, and other alternatives can also be provided where one or more steps are added, one or more steps are removed, or one or more steps are provided in a different sequence without departing from the scope of the claims herein.

There is provided a computer program product comprising instructions that, when executed by a computer, cause the computer to execute the method 200. In an example, the instructions are implemented on the computer-readable media, which include, but are not limited to, Electrically Erasable Programmable Read-Only Memory (EEPROM), Random Access Memory (RAM), Read-Only Memory (ROM), Hard Disk Drive (HDD), Flash memory, a Secure Digital (SD) card, Solid-State Drive (SSD), a computer-readable storage medium, and/or CPU cache memory. In an example, the instructions are generated by a computer program, which is implemented in view of the method 200 and for use in implementing the method 200 in a virtual machine.

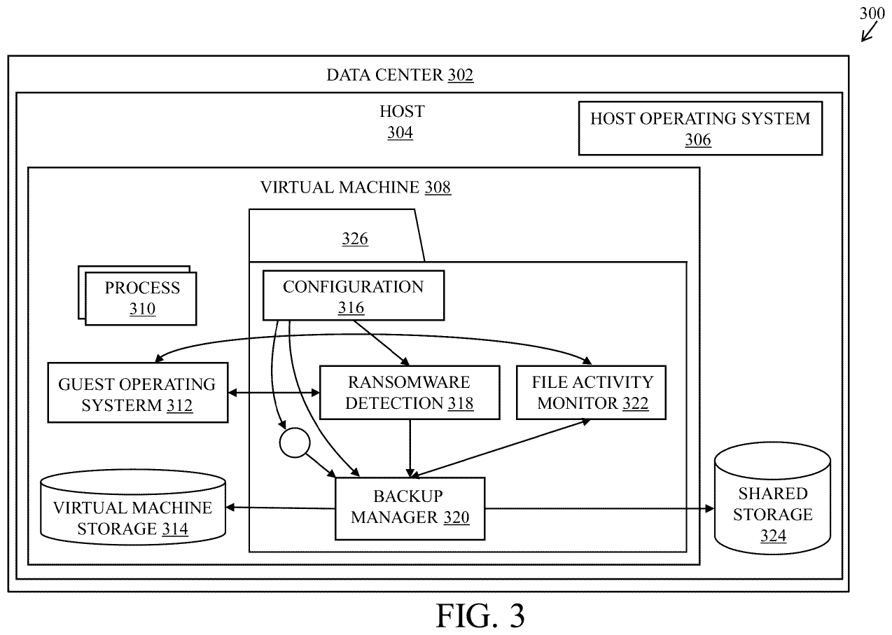

FIG. 3 depicts an exemplary diagram that depicts an architecture of a computer system, in accordance with an embodiment of the present disclosure. FIG. 3 is described in conjunction with elements from FIG. 1. With reference to FIG. 3 there is shown an exemplary diagram 300 that depicts the architecture of the computer system 104 in a virtual machine.

In an implementation scenario, a data centre 302 includes a host 304 that further includes a host operating system 306, a shared storage 324, and a virtual machine 308 (or the computer system 104 of FIG. 1) to provide zero-loss ransomware protection. The virtual machine 308 includes a process 310, a guest operating system 312 (or the operating system 106 of FIG. 1) and a virtual machine storage 314 (or the at least one memory disk 108). Moreover, a memory disk request is received for a file, which is stored in the virtual machine storage 314. Furthermore, the virtual machine 308 is configured to determine that the memory disk request is a WRITE request indicating a modification to the file and, in response, thereto generate a backup copy of the file prior to the modification, which can be accessed through a backup manager 320. Moreover, operating system services are used to perform file activity monitoring, such as through a file activity monitor 322. Furthermore, the processes that include the ransomware are determined, such as through ransomware detection 318. Thereafter, a ransomware alert for the corresponding process that includes the ransomware is sent to the virtual machine 308. In addition, the files are recovered even after the modification of the file by the process 310 that includes the malware, such as by replacing the modified copy of the file with the backup copy of the file by the backup manager 320 to eliminate the adverse effect of the ransomware attack. Thus, enables zero-loss ransomware protection, such as through a zero-ransomware protection agent 326 to the virtual machine 308 with improved overall data security.

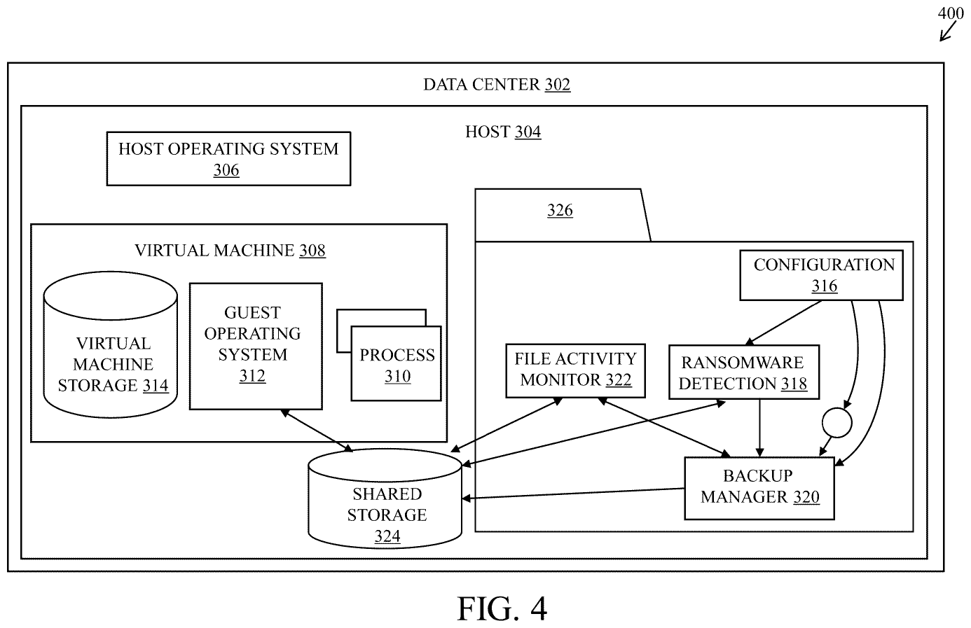

FIG. 4 depicts an exemplary diagram that depicts monitoring by a virtual machine monitor, in accordance with an embodiment of the present disclosure. FIG. 4 is described in conjunction with elements from FIGS. 1 and 3. With reference to FIG. 4, there is shown a diagram 400 that depicts the monitoring by the virtual machine monitor, such as through a virtual machine monitor method.

In an exemplary scenario, the zero-ransomware protection agent 326 is configured to receive a memory disk request for a file and further generate a backup copy of the file prior to the modification of the file if the memory disk request is a WRITE request. Furthermore, the ransomware detection 318 is used to determine that the process includes the ransomware and, in response thereto, recover the file based on the backup copy that is handled by the backup manager 320 and further delete the backup copy that is generated before the modification of the file as requested by the process 310. Furthermore, the zero-ransomware protection agent 326 is configured to determine if the process, such as the process 310 is timed out, such as through the backup manager 320, then, in that case, the zero-ransomware protection agent 326 is configured to terminate the process 310. Thus, the zero-ransomware protection agent 326 includes the file activity monitor 322, the ransomware detection 318, and the backup manager 320 are used to generate the backup copy of the file for which the WRITE request is received in order to restore the file that is modified by the process, such as the process 310 that includes the malware. Hence, the zero-ransomware protection agent 326 is configured to eliminate the adverse effect of the ransomware and improves the overall data security of the host 304 (i.e., the computer system 104).

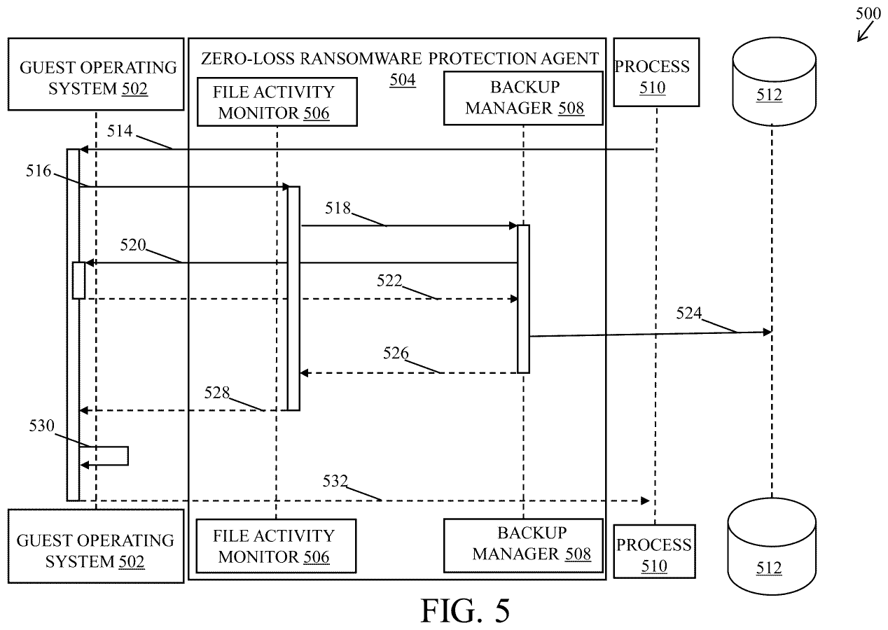

FIG. 5 depicts an exemplary diagram that depicts an execution of the memory disk request for a file, in accordance with an embodiment of the present disclosure. FIG. 5 is described in conjunction with elements from FIGS. 1, 3 and 4. With reference to FIG. 5, there is shown a diagram 500 of the flow of the execution of the memory disk request for a file. The diagram 500 depicts operations from 514 to 532. There is further shown a guest operating system 502 and a zero-loss ransomware protection agent 504 that includes a file activity monitor 506 and a backup manager 508 configured to perform the operations shown in the diagram 500. The diagram 500 depicts a process 510, which is executed within the guest operating system 502 to write to a file. Furthermore, a notification is transmitted to the file activity monitor 506, which notifies the backup manager 508 to backup the file to allow the modification of the file.

At operation 514, the guest operating system 502 is configured to receive the process 510 (i.e., a memory disk request) that indicates a WRITE request indicating a modification of the file. Furthermore, at operation 516, the guest operating system 502 is configured to send the notification for the memory disk request that indicates the WRITE request to the file activity monitor 506. At operation 518, the file activity monitor 506 is configured to create a copy of the WRITRE request notification and send it to the backup manager 508. Furthermore, at operation 520, the backup manager 508 is configured to get the data of the original file, and further, the guest operating system 502 is configured to transmit the data of the original file to the backup manager 508, such as at operation 522. Thereafter, at operation 524, the backup manager 508 is configured to store the data of the original file in a zero-loss backup storage 512 and create a copy of the data of the original file at the file activity monitor 506, such as at operation 526. Thereafter, at operation 528, the file activity monitor 506 is configured to transmit the feedback of the notification to the guest operating system 502 and perform WRITE requests, such as at operation 530. Finally, the process 510 is completed by the guest operating system, such as at operation 532. Thus, the backup of the file is created before the modification of the file to recover the file in future if, in any case, the file is affected by the ransomware.

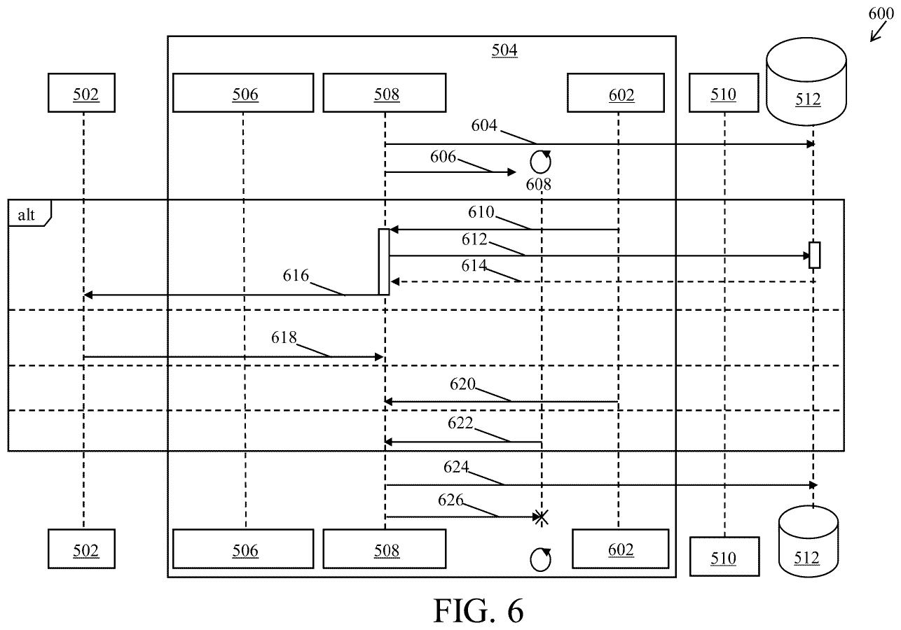

FIG. 6 depicts an exemplary diagram that depicts a sequence of execution of a process, in accordance with an embodiment of the present disclosure. FIG. 6 is described in conjunction with elements from FIGS. 1, 3, 4 and 5. With reference to FIG. 6, there is shown a diagram 600 of the flow of the execution of the memory disk request for a file. The diagram 600 depicts operations from 604 to 626. The guest operating system 502 (of FIG. 5) and the zero-loss ransomware protection agent 504 (of FIG. 5), which includes the file activity monitor 506 (of FIG. 5) and the backup manager 508 (of FIG. 5), are configured to perform the operations shown in the diagram 600. The diagram 500 depicts a restoration of the file after the modification by the process 510, which includes malware, such as through a backup copy of the file, which is detected through a ransomware detector 602.

At operation 606, the backup manager 508 is configured to write data of an original file to the zero-loss backup storage 512 and to detect if the process, such as the process 510 includes malware or if the timeout occurred during the execution of the process 510, such as at operation 608. Furthermore, at operation 610, the ransomware detector 602 is configured to detect that the process 510 includes the malware. Thereafter, at operation 612, the backup manager 508 is configured to retrieve the data of the original file from the zero-loss backup storage 512. Thereafter, at operation 614, the data of the original file is transmitted to the backup manager 508. Furthermore, the backup manager 508 is configured to transmit the data of the original file to the guest operating system 502, such as at operation 616. After that, the process 510 is terminated, such as at operation 618, after the detection of the malware by the ransomware detector 602, such as at operation 620. Furthermore, at operation 622, the ransomware detector 602 is configured to detect that the timeout for the process is reached, then, in that case, the backup manager 508 is configured to delete the backup created before the modification of the process 510, such as at operation 624 and further delete the timeout, such as at operation 626. Thus, the file that is modified by the process 510, which includes the malware, is recovered by the creation of the backup copy, and thereafter, the backup copy is deleted to reduce the resource utilization and improves the overall data security of the computer system 104.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A protection controller (102) configured to operate in a computer system (104) comprising a process, an operating system (106) and at least one memory disk (108), wherein the protection controller (102) is further configured to
receive a memory disk request for a file;
determine that the memory disk request is a WRITE request indicating a modification to the file, and, in response thereto
generate a backup copy of the file prior to the modification;
determine that the process comprises ransomware; and, in response thereto
recover the file based on the backup copy.

2. The protection controller (102) according to claim 1, wherein the protection controller (102) is further configured to monitor the process for receiving the memory disk request.

3. The protection controller (102) according to claim 1, wherein the protection controller (102) is further configured to monitor the operating system for receiving the memory disk request.

4. The protection controller (102) according to claim 1, wherein the protection controller (102) is further configured to monitor the at least one memory disk (108) for receiving the memory disk request.

5. The protection controller (102) according to any preceding claim, wherein the protection controller (102) is further configured to receive the memory disk request for the file by utilizing operating system services to perform file activity monitoring.

6. The protection controller (102) according to any preceding claim, wherein the protection controller (102) is further configured to recover the file by replacing the modified file with the backup copy.

7. The protection controller (102) according to any preceding claim, wherein the protection controller (102) is further configured to recover the file by replacing modified blocks in the modified file with corresponding blocks in the backup copy.

8. The protection controller (102) according to claim 7, wherein the protection controller (102) is further configured to generate the backup copy as consisting of the modified blocks.

9. The protection controller (102) according to any preceding claim, wherein the protection controller (102) is further configured to determine that the process has been terminated and in response thereto delete the backup copy.

10. The protection controller (102) according to any preceding claim, wherein the protection controller (102) is further configured to determine that the process does not comprise ransomware and in response thereto delete the backup copy.

11. The protection controller (102) according to claim 10, wherein the protection controller (102) is further configured to determine that the process does not comprise ransomware by receiving an indication to this effect.

12. The protection controller (102) according to any preceding claim, wherein the protection controller (102) is further configured to determine that a timeout has occurred and in response thereto delete the backup copy.

13. The protection controller (102) according to any preceding claim, wherein the computer system (104) is a virtual machine system.

14. A method (200) for a protection controller (102) configured to operate in a computer system (104) comprising a process, an operating system (106) and at least one memory disk (108), wherein the method (200) comprises:
receiving a memory disk request for a file;
determining that the memory disk request is a WRITE request indicating a modification to the file, and, in response thereto
generating a backup copy of the file prior to the modification;
determining that the process comprises ransomware; and, in response thereto recovering the file based on the backup copy.

15. A computer program product comprising program instructions for performing the method (200) according to claim 14, when executed by one or more processors in a virtual machine system.
